(19) United States
(12) Patent Application Publication
(10) Pub. No.: US 2009/0144174 A1
(43) Pub. Date: Jun. 4, 2009

(54) Drag-and-drop customization of jewelry

(75) Inventor: Kavita Reddy, Irvine, CA (US)

Correspondence Address: Kavita Reddy, 181 Alicante Aisle, Irvine, CA, 92614, US

(73) Assignee: Facets of You LLC

(21) Appl. No.: 12/220,538

(22) Filed: Jul. 25, 2008

Related U.S. Application Data
(60) Provisional application No. 60/961,922, filed on Jul. 25, 2007.

(51) Int. Cl. G06Q 30/00; G06F 17/30; G06Q 90/00

(52) U.S. Cl. 705/27; 705/26

(57) ABSTRACT

An inventive method and system for allowing visitors of a web site to customize design elements into a final unique design through the use of an intuitive drag-and-drop or click-and-place method of assembly is presented. The inventive method and system enable better simulation of the highly visual, interactive, experimental and iterative creative design process employed by people when building artistic designs including jewelry. The drag-and-drop or click-and-place technique of putting gemstones into settings is analogous to an artist creating a painting by iteratively picking up a particular paint color with a paintbrush and placing the selected paint on a particular spot on a canvas.

### FIELD OF THE INVENTION

This invention relates to an Internet jewelry retail site.

### BACKGROUND OF THE INVENTION

Several World Wide Web (hereinafter “web”) sites exist for retail of jewelry. Examples include www.ice.com, www.jewelry.com, and www.zales.com. Some of these sites, such as www.jewelsforme.com, http://www.walmart.com (personalized jewelry) enable customers to customize the jewelry by selecting gemstones prior to purchase, through pull down menus made available by the web site.

These customization techniques however, are cumbersome and do not provide a visually appealing and convenient graphical user interface (hereinafter “GUI”) that allows the visitor to the jewelry web site to rapidly experiment with assembling and viewing customized gemstone jewelry designs prior to placing an order on the web site for such customized jewelry. More specifically, no system known in the art enables users to assemble combinations of gemstones and settings for rapid viewing prior to purchase through a convenient and mechanically appealing “drag-and-drop” or “click-and-place” technique. All web sites that allow users to experiment with assembling gemstone jewelry do so through textual menu driven techniques which do not provide the experimenting visitor a visually intuitive method for selecting gemstones for settings. There is a need for “drag-and-drop” or “click-and-place” driven gemstone jewelry assembly mechanism in customer-designed jewelry web sites to simulate the highly visual, interactive, experimental, and iterative creative design process employed by people when building artistic designs including jewelry.

### BRIEF SUMMARY OF THE INVENTION

The inventive web site described herein allows its visitors to customize jewelry selections to create a true reflection of her or his tastes. The web site allows its visitors to assemble combinations of design elements, such as settings, gemstones, earring backs, earring lever backs, pendant bails and necklace fastenings, into a final unique design through the use of an intuitive method of assembly. This unique approach lets any visitor mix and match design elements such as gemstones and settings to create beautiful jewelry designs that are uniquely her/his own using a “drag-and-drop” or “click-and-place” graphical user interface (“GUI”) on the web site. Visitors to the inventive site can use drag-and-drop or click-and-place techniques on the GUI, for example, to choose from a selection of gemstones that vary in type, size, cut and quality among other traits, and then match the selected gemstones with any of a number of settings including a variety of earrings and rings. The drag-and-drop and click-and-place methods of assembling design elements into a final artistic product are more intuitively analogous to the real life design process than currently used menu-driven assembly methods.

### BRIEF DESCRIPTION OF THE SEVERAL VIEWS OF THE DRAWING

FIGS. 1a, 1b, 1c and 1d illustrate a first embodiment of this invention, which includes a Creation Palette.

FIGS. 2a to 2d illustrate a second embodiment of this invention, which includes a Virtual Design and a Creation Palette.

FIG. 3 illustrates the high level software architecture of an embodiment of the invention.

FIG. 4 illustrates the design and deployment architecture of an embodiment of the invention.

### DETAILED DESCRIPTION OF THE INVENTION

The web site allows its visitors to customize design elements into a final unique design through the use of an intuitive method of combining design elements into jewelry designs. Visitors to the inventive site can create customized jewelry through the use of drag-and-drop and/or click-and-place techniques on the GUI. A selection of gemstones that vary in type, size, cut and quality among other traits, can be matched with any of a number of settings including a variety of earrings and rings, through an intuitive drag-and-drop or click-and-place technique. The drag-and-drop or click-and-place technique of putting gemstones into settings is analogous to an artist creating a painting by iteratively picking up a particular paint color with a paintbrush and placing the selected paint on a particular spot on a canvas.

The process begins with the user dragging and dropping a selected setting on to a Creation Palette on the web page. A Creation Palette resembles an artist's paint palette, except that (A) its focal point is a selected setting rather than a mixture of paints that are about to be applied to a canvas, and (B) the focal point (i.e., the setting) is surrounded by gemstones rather than paint colors. A Creation Palette can be considered a virtual artist's studio. The selected setting will be the focal point of the Creation Palette until a new setting is selected for replacement. The visitor then drags and drops one or more these gemstones into the setting on the Creation Palette to create a unique combination. The visitor can alternatively use a click-and-place technique to place gemstones into the setting on the Creation Palette. In the click-and-place technique, the visitor clicks on a gemstone of interest to select it, and then places the selected gemstone into a slot on the setting, designed to accommodate a gemstone, by subsequently clicking on the appropriate area of the setting. The selected gemstone is placed into the selected area of the setting resulting in a unique combination. The visitor can then examine the unique combination by rotating the resulting jewelry from 0-360 degrees within the Creation Palette around any axis. The resultant jewelry can also be displayed on a virtual easel for display and rotation. The virtual easel can illustrate a hand, neck, ear, navel, or other body part that could wear the resultant jewelry. On both the Creation Palette and virtual easel, the jewelry can be inspected and further modified prior to purchase.

The Creation Palette can also be combined with a virtual easel, also referred to herein as a Virtual Design Canvas. The visitor can use the Virtual Design Canvas to experiment with design elements, including but not limited to gemstones and settings, to create a final jewelry design. The Virtual Design Canvas can be represented as a picture frame in which the focal point is a selected setting. The gemstones are located in an accompanying creation palette. The visitor may begin to assemble the design elements into the final design (i.e. jewelry piece) by dragging and dropping the elements into place inside the Virtual Design Canvas.

During the assembly process in the Creation Palette, the visitor is presented with possible suggested combinations to help in the selection of gemstones to complete the design. Suggestions may include color tones (warm, cool, pinks, blues, contrasts, compliments etc.), birthstones, astrologically complimentary gemstones based on birth-date and time, gemstones matching a pre-specified list of the visitor's favorite colors, price category, gemstone cut, gemstone quality, fashionably current colors and gemstones, seasonal themes (red and green at Christmas, reds and pinks at Valentines), and cultural relevance (Jade for Chinese culture, green for Irish culture). As the visitor to the inventive site assembles combinations of gemstones and settings, prices are automatically displayed to the visitor in conjunction with the newly assembled and displayed combination. The pricing information could be obtained using several techniques including an interface into a database that contains pricing for gemstones, settings and combinations (i.e., the price of combining certain gemstones and settings will often vary from combination to combination, independent of the price of the constituent gemstones and settings themselves). Combinations of gemstones and settings that are impossible to assemble are flagged to the visitor as soon as she attempts to assemble and view the combination. Additionally, combinations of gemstones and settings with which the visitor has experimented are saved and displayed in a Your Previous Creations place on the web site, available to the visitor for viewing within the current visit or subsequent visits.

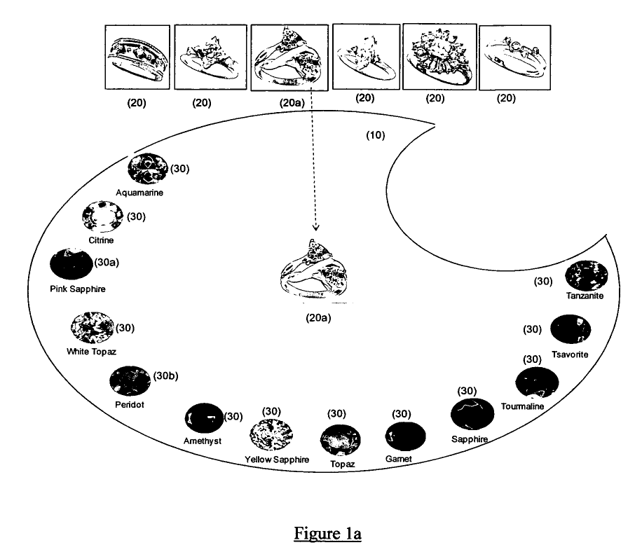

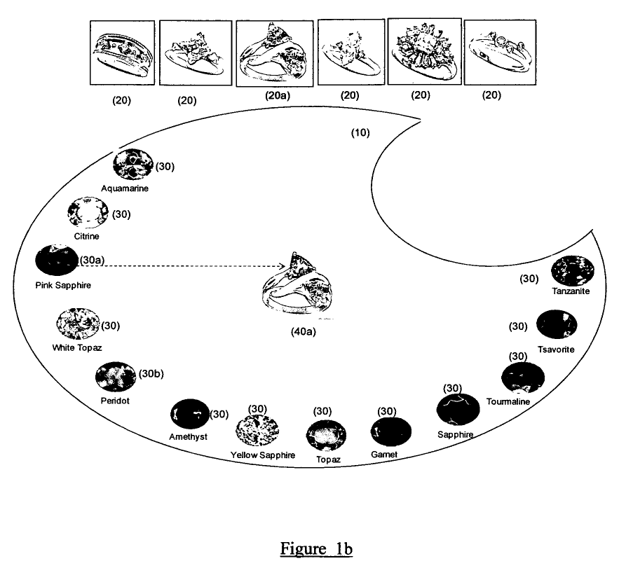

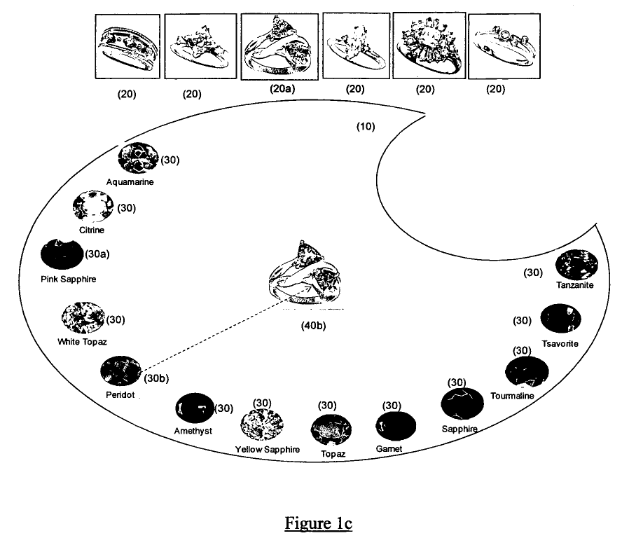

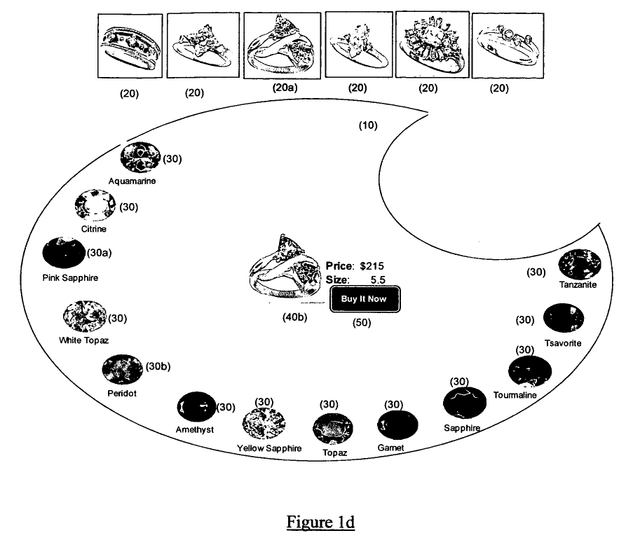

FIGS. 1a, 1b, 1c and 1d illustrate an embodiment of this invention that includes a Creation Palette (10), various design elements (gemstones (30) and various settings (20)) and FIGS. 1b, 1c, 1d additionally illustrate designs (40a and 40b). A visitor's interactions with the inventive web site are described in these figures. As FIG. 1a illustrates, an offering of settings (20) set with neutrally colored gemstones (30) are displayed to the visitor. The visitor drags a desired setting (20a) on to the Creation Palette (10). The gem selection then begins. As FIG. 1b shows, a first selected gemstone (30a) is dragged and dropped (or clicked and placed) into the setting (20a) resulting in an updated jewelry design (40a) consisting of the original setting of interest (20a) and the selected gemstone (30a). In FIG. 1c, a second gemstone (30b) is dragged and dropped (or clicked and placed) into the previously updated design (40a) resulting in a newly updated jewelry design (40b). At this point, the visitor has decided that this is the final design (40b) which now comprises the first and second selected gemstones (30a and 30b) and the setting (20a). No more gemstone placement is required since the visitor is satisfied with the final design (40b). The visitor will have just designed a unique piece of jewelry that reflects his/her tastes. Once the final design is completed, as shown in FIG. 1d, the user is presented with a display (50) indicating the cost of the final design as well as an option to purchase. The cost varies depending on the type, cut, size and shape of gemstones selected. The visitor can select “Buy It Now” to complete her purchase of the resulting self-designed jewelry.

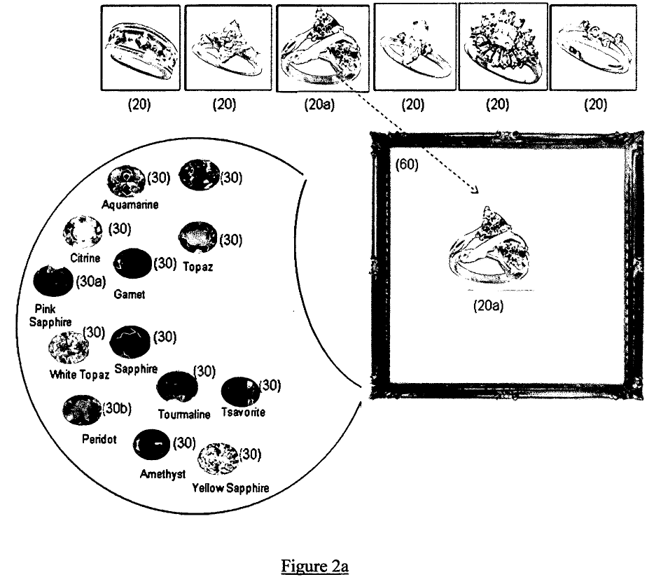

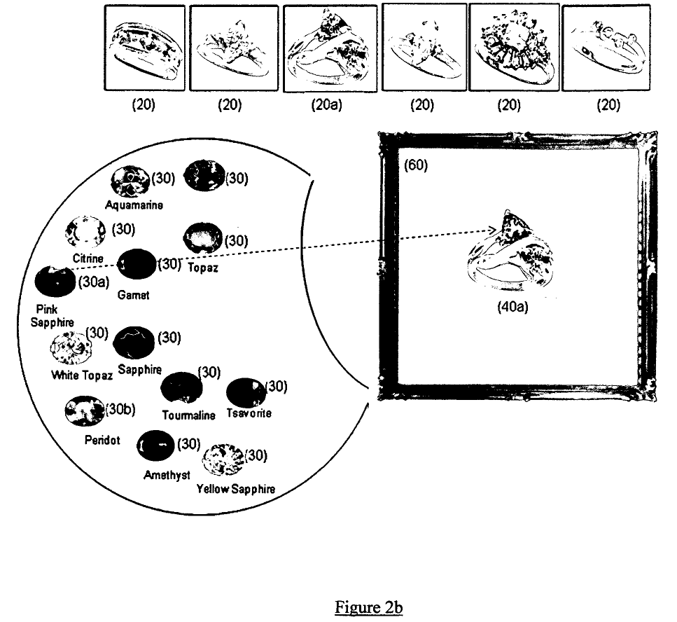

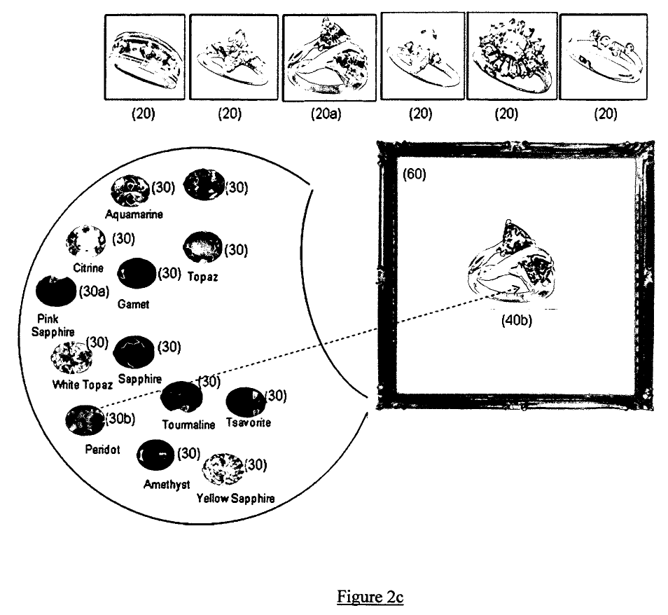

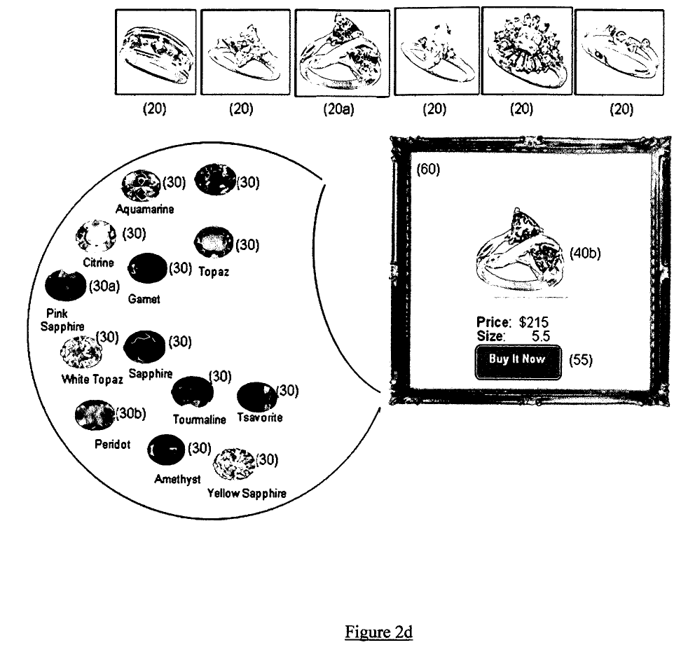

FIGS. 2a, 2b, 2c and 2d illustrate an embodiment of this invention that includes the Virtual Design Canvas (60) the design elements (gemstones (30) and settings (20)) and FIGS. 2b, 2c and 2d additionally illustrate designs (40a and 40b). FIG. 2a shows the initial dragging and dropping of a setting (20a) onto the Virtual Design Canvas (60). The setting (20a) now becomes a setting of interest. The placement of a first gemstone (30a) through dragging and dropping (or clicking and placing) into the setting of interest (20a) is depicted in FIG. 2b and results in an updated jewelry design (40a) consisting of the original setting of interest (20a) and the selected gemstone (30a). FIG. 2c illustrates the addition of a second gemstone (30b) resulting in a newly updated jewelry design (40b). If the visitor is satisfied with the final design (40b) no more gemstone placement is required. The user may select go to the area (55) and see the final cost of the final design (40b) shown in FIG. 2d and select “Buy It Now.”

The use of a drag-and-drop (or click-and-place) method to combine design elements into final designs can be extended to other retail items that can be customized, for example, online including fashion items (e.g. outfits), automobiles or furniture.

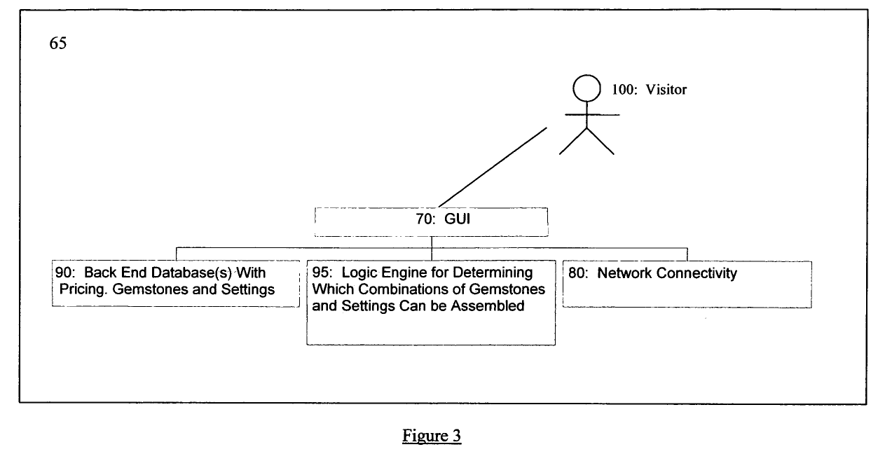

The web site can be implemented by creating a software system that is implemented using an object-oriented program coded in C#, for execution on a web server. The software system can also be implemented using HTML, Javascript and Ajax on the web client. The web server portion can be implemented with a server-side language like PHP, ASP or ColdFusion and an SQL database on the web server. Other coding languages and software program methodologies could be used without departing from the spirit of this invention. The architecture of an embodiment of the inventive system (65) is illustrated in FIG. 3. The system (65) includes a graphical user interface (GUI) subsystem (70) for interacting with a visitor (100), a network connectivity subsystem (80) for connecting the visitor (100) (who would be using a computer to access the network) to the rest of the system (65), a backend database (90) for holding pricing, gemstone, setting and other information needed to enable the visitor (100) to customize and purchase jewelry she has assembled, and a logic engine (95) for ensuring that the user cannot assemble combinations of gemstones and settings that are impossible, uneconomical or otherwise infeasible to manufacture and/or sell.

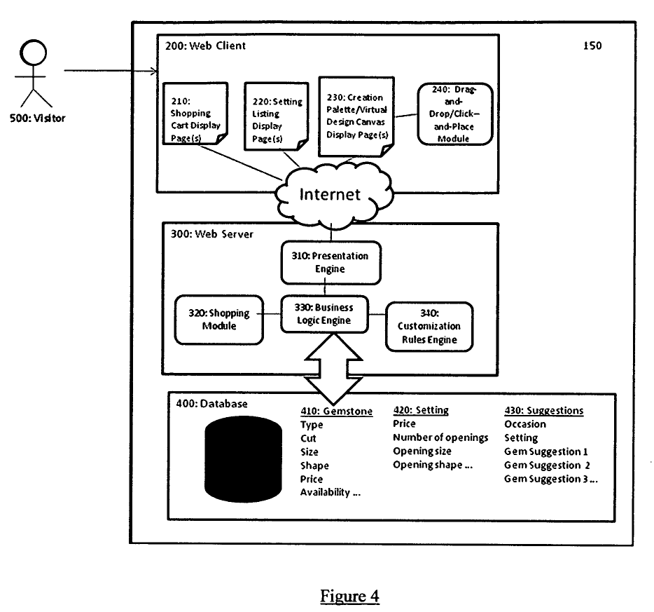

FIG. 4 presents the deployment architecture of another embodiment (150) of the inventive system. The system (150) is deployed on a Web Client (200), a Web Server (300) and a Database (400). The Web Client (200) is responsible for displaying to the visitor (500) a listing of settings (220), the Creation Palette (or Virtual Design Canvas) (230), the contents of their shopping cart (210). The Web Client (200) also contains a module (240) for processing the drag-and-drop (or click-and-place) input received from the visitor (500). The Web Server (300) houses the modules responsible for Customization Rules (340), the visitor's Shopping cart (320), Business Logic (330) and a Presentation (310). The Database (400) contains design element (gemstones (410) and settings (420)) and combination suggestion information (430).

When a visitor (500) visits the inventive site and requests a list of settings, the Business Logic Engine (330) communicates with the Database (400) to obtain a list of available Setting (420) design elements. The Presentation Module (310) interacts with the Business Logic Engine (330) module to convert the list of settings into a web format ready for display on the web client (Setting Listing Display Page (220)). The visitor (500), having looked over the listing of settings, decides on a particular setting to customize. The Business Logic Engine (330) communicates with the Database (400) to obtain customization-specific information regarding the selected setting from the Setting data structure (420). The Business Logic Engine (330) calls the Customization Rules Engine (340) to calculate the valid gemstones for the setting as well as some suggested combinations. The Customization Rules Engine (340) works with the Database (400) to obtain a list of gemstones from the Gemstone data structure (410). Using rules about cut, shape, availability and size of both the setting of interest and the gemstones, the Customization Rules Engine (340) produces a set of valid gemstones for the setting. The Customization Rules Engine (340) also obtains suggested combinations for the setting from the Suggestions data structure (430). The Customization Rules Engine (340) provides the list of valid gemstones and combinations to the Business Logic Engine (330) which in turn tells the Presentation Engine (310) to translate the gemstones and suggestions for display on the web client. The Presentation Engine (310) creates the display code for the Creation Palette/virtual Design Canvas page (230) with the valid gemstones and suggested combinations. The Creation Palette/Virtual Design Canvas page (230) instantiates an instance of the Drag-and-Drop/Click-and-Place module (240). The Drag-and-Drop/Click-and-Place module enables the user to drag-and-drop (or click-and-place) the gemstones into the setting of interest by processing the mouse strokes that signify the appropriate movements.

Once the visitor (500) has created a final jewelry design, they can select the “Buy It Now” button that is displayed on the Creation Palette/Virtual Design Canvas page (230). When the button is pressed, the Business Logic Engine (330) tells the Shopping Module (320) to save this information into the user's session data and instructs the Presentation Engine (310) to update the Shopping Cart Display page (210) with the setting, the gemstones selected, the quantity and price. If the user decides to complete the order, the Business Logic Engine (330) and Shopping Cart Module (320) will take the user through the order processing steps which includes permanent order storage in the Database (400) and payment processing.

What is claimed is:

1. A method for selling a piece of jewelry to a visitor of a web site, the jewelry piece based on a design comprising at least one setting and one gemstone, said method comprising:
a) displaying a plurality of gemstone design elements for selection by the visitor;
b) displaying a plurality of setting design elements for selection by the visitor;
c) receiving visitor input that indicates dragging and dropping of a selected setting design element into a jewelry design; and
d) receiving visitor input that indicates dragging and dropping of a selected gemstone design element into the jewelry design.

2. The method of claim 1 wherein the jewelry design is put together inside a creation palette.

3. The method of claim 1 wherein the jewelry design is put together inside a virtual design canvas.

4. The method of claim 3 wherein the design elements are dragged and dropped from a creation palette onto the virtual design canvas.

5. The method of claim 1 comprising the additional step of providing the visitor with one or more possible suggested combinations of design elements.

6. The method of claim 1 comprising the additional step of displaying a price for the jewelry design and offering a piece of jewelry based on the design for sale to the visitor.

7. The method of claim 6 comprising the additional step of passing the jewelry design to a rules engine for determining whether or not the piece of jewelry based on the design can be offered for a sale, prior to offering the piece of jewelry for sale.

8. A method for selling a piece of jewelry to a visitor of a web site, the jewelry piece based on a design comprising at least one setting and one gemstone, said method comprising:
a) displaying a plurality of gemstone design elements for selection by the visitor;
b) displaying a plurality of setting design elements for selection by the visitor;
c) receiving visitor input that indicates clicking and placing of a selected setting design element into a jewelry design; and
d) receiving visitor input that indicates clicking and placing of a selected gemstone design element into the jewelry design.

9. The method of claim 8 wherein the jewelry design is put together inside a creation palette.

10. The method of claim 8 wherein the jewelry design is put together inside a virtual design canvas.

11. The method of claim 10 wherein the design elements are clicked and placed from a creation palette onto the virtual design canvas.

13. The method of claim 8 comprising the additional step of providing the visitor with one or more possible suggested combinations of design elements.

14. The method of claim 8 comprising the additional step of displaying a price for the jewelry design and offering a piece of jewelry based on the design for sale to the visitor.

15. The method of claim 14 comprising the additional step of passing the jewelry design to a rules engine for determining whether or not the piece of jewelry based on the design can be offered for a sale, prior to offering the piece of jewelry for sale.

16. A method of enabling a website visitor to create a design by combining a plurality of different types of design elements, said method comprising:
a) displaying a set of design elements of a first type;
b) displaying a set of design elements of a second type;
c) receiving drag-and-drop user input for combining a design element of the first type with a design element of the second type;
d) displaying the resulting combination.

17. The method of 16 wherein an item based on the design is offered for sale.

18. The method of 16 wherein the drag-and-drop user input is replaced by click-and-place user input.

19. The method of 18 wherein an item based on the design is offered for sale.

20. A method of offering for sale an item based on an interactively created design on a web site, said design comprising a plurality of design elements, said method comprising:
a) receiving drag-and-drop user input that seeks to combine a design element with another design element to create a final design;
b) continually updating the web site display responsive to said user input; and
c) displaying the resulting design in a fixed location on the web site display when said user input has stopped being received.

21. The method of 20 wherein the drag-and-drop user input is replaced by click-and-place user input.
